(19) United States
(12) Patent Application Publication
(10) Pub. No.: US 2024/0419520 A1
(43) Pub. Date: Dec. 19, 2024

(54) SYSTEM AND METHOD FOR APPLICATION PROGRAMMING INTERFACE MANAGEMENT

(71) Applicant: JIO PLATFORMS LIMITED, Ahmedabad (IN)

(72) Inventors: Ameya MUNAGEKAR, Mumbai (IN); Akansha KUMAR, Hyderabad (IN); Kamlesh DHONDGE, Pune (IN); Akhil Patel PATLOLLA, Sangareddy (IN)

(73) Assignee: JIO PLATFORMS LIMITED, Ahmedabad (IN)

(21) Appl. No.: 18/704,296

(22) PCT Filed: Oct. 29, 2022
(86) PCT No.: PCT/IB2022/060433

§ 371 Date: Apr. 24, 2024

(30) Foreign Application Priority Data
Oct. 29, 2021 (IN) 202121049703

(51) Int. Cl. G06F 9/54

(52) U.S. Cl. CPC G06F 9/547

(57) ABSTRACT

The present invention provides a robust and effective solution to an entity or an organization by developing a complete suite for management of many APIs enabling a user to create an API (Application Programming Interface) for a platform and enabling at least one other user to use a created API for this platform. Embodiments herein disclose a system which complies with component-based and service-oriented concepts of API architecture, and by providing next generation tools and libraries for open-standards based multi-channel application development by automated generation of APIs and interactive consumption of the APIs via one single portal for performing functionalities such as documentation, execution, flow batching of APIs, onboarding new APIs and creating a competitive marketplace for APIs.

### FIELD OF INVENTION

The embodiments of the present disclosure herein relate to creating and managing solutions for a platform and, more particularly, to enabling a user to a complete suite for management of multiple application programming interface (API) with factors such as documentation, execution, flow batching of APIs, onboarding new APIs and creating a competitive marketplace for APIs.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Application Programming Interfaces (APIs) are communication mechanism between services. An API lifecycle is usually driven by an API provider (who may be responding to consumer requests). APIs may exist in various versions and software lifecycle states within a system landscape and are frequently developed like any software by API developers (including those of API consumers) using an integrated development environment (IDE). After a successful test within an IDE, a particular API is usually deployed in a test/quality landscape for further tests (e.g., integration tests). After successful further tests, the API is deployed in a productive landscape. These states (e.g., development version, test/quality version, and productive version) are typically managed by the API provider. Services hold the business logic for a task. These APIs are exposed for a consumer for usage over network with many different interfaces such as Rest, SOAP, GRPC or custom home-made interfaces. As the services grow, the number of APIs increases in size and it becomes difficult to manage all remote APIs at a single place for an organization.

Problems occur when APIs grow within an enterprise and there is a huge amount of inconsistent APIs when there is a need of reinventing common modules, locating and consuming multiple API from different teams, onboarding new APIs as per end user's requirements, using a chain of APIs for a particular task and the like.

For example, inconsistent API is like a contract between the consumer and the service, but there is no fixed contract that everyone follows. Multiple Teams can adopt to different formats of query, different schemas for detonating pages in case of paginated APIs. This leads the end consumer to learn the usage of an API all over again for every other API and must manually keep a track of it. There is no single place to find the APIs. Since the APIs are developed in silos within teams for a specific use case, collaboration becomes difficult when consumers from cross teams and want to consume the APIs. When a product depends on multiple team's APIs, constant communication, follow-up decreases the productivity of overall project and slows down delivery. Another important drawback is chaining of API as per use case. Enterprise level use cases need sequence of APIs in a batch format to complete a task. This sequence is needed to be created as per business logic and by the end user on its own. It has common pitfalls of increasing network traffic, latency, of data moving to and fro API execution machines to end user. There is no single endpoint of execution for using an API. Onboarding new APIs can create another issue. Centrally onboarding API is an issue, as each team/department develops and hosts API in their own environment. As a result, understanding and working on a large number of APIs create confusion among consumers.

Another drawback is competition between APIs. There will be multiple APIs that solve the same problem, and it is difficult for a consumer to find out the best possible API for a particular service.

There is therefore a need in the art to provide a system and a method that can overcome the shortcomings of the existing prior art.

### OBJECTS OF THE PRESENT DISCLOSURE

Some of the objects of the present disclosure, which at least one embodiment herein satisfies are as listed herein below.

An object of the present disclosure is to provide for a system and method to have an interactive documentation, a place which displays information related to use cases, how to use, variants of an API in easy to read and consumable format.

An object of the present disclosure is to provide a system and method to have a process-oriented onboarding of new APIs into the system.

An object of the present disclosure is to provide a portal to add new APIs into the ecosystem and enabling it with execution with all other components.

An object of the present disclosure is to provide a system and method to develop custom solutions consuming one or more multiple APIs, chaining them as flow, sequential or parallel and exposing the complete solution as a single API.

An object of the present disclosure is to provide a system and method that can act as a marketplace for all the existing APIs in the bank.

An object of the present disclosure is to provide a platform to the end users where they can submit reviews, provide ratings, subscribe/unsubscribe to APIs for consumption.

An object of the present disclosure is to provide a system and method that can execute APIs from different places which could be executed on a single platform.

An object of the present disclosure is to provide a system and method that can take care of common considerations about rate limiting, authentication, different protocols interface and different modes of execution such as synchronous and asynchronous so that a developer need not worry about it.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a system for facilitating management of a plurality of application programming interfaces (API). The system may include a processor coupled to one or more computing devices in a network, the processor further coupled with a memory that stores instructions which when executed by the processor may cause the system to receive, by an API curate module, a plurality of APIs from the one or more computing devices. In an embodiment, the API curate module may be associated with the processor. The system may be further configured to receive, by the API curate module, a set of parameters from the one or more computing devices, the set of parameters pertaining to a predefined set of instructions associated with the plurality of APIs. Based on the received set of parameters, the system may arrange, by an API flow module, the plurality of APIs into one or more batches. In an embodiment, the API flow module may be associated with the processor and display, by the API flow module, a single API from each batch to the user.

In an embodiment, the system may be further configured to create, by the API flow module, one or more custom solutions for the plurality of APIs executing parallelly or sequentially and execute, by the API flow module (360), the plurality of APIs in a single platform.

In an embodiment, the system may be further configured to onboard, by the API curate module, a new API based on a predefined set of instructions.

In an embodiment, the system may be further configured to determine a cumulative service level agreement (SLA) of each API applicable for each computing device.

In an embodiment, the system may be further configured to store the plurality of APIs, the new API and one or more deployed APIs from the one or more batched in an API Bank.

In an embodiment, the system may be further configured to receive one or more details associated with one or more interactive documentation, one or more marketplace documentation, API flows, a plurality of modes and the SLAs associated with the plurality of APIs and the new API.

In an embodiment, the system may be further configured to manage the one or more details associated with the one or more interactive documentation, the one or more marketplace documentation, the API flows, the plurality of modes, the SLAs associated with the plurality of APIs and the new API.

In an embodiment, the system may be further configured to receive a request from a user computing device for a new API to be developed.

In an embodiment, the system may be further configured to store in an API console the one or more interactive documentation.

In an embodiment, the system may be further configured to execute, by an API Management Suite, the plurality of APIs as a flow synchronously, asynchronously, sequentially or parallelly as a single API. In an embodiment, the API Management Suite may be associated with the processor.

In an embodiment, the system may be further configured to receive, by the API Management Suite, reviews, ratings, subscriptions for API consumption from the one or more computing devices associated with one or more users.

In an embodiment, the system may be further configured to authenticate, by the API Management Suite, the plurality of APIs.

In an aspect, the present disclosure provides a method for facilitating scheduling of a plurality of application programming interfaces (API). The method may include the step of receiving, by an API curate module, a plurality of APIs from the one or more computing devices. In an embodiment, the API curate module may be associated with a processor coupled to one or more computing devices in a network. In an embodiment, the processor may be further coupled with a memory that stores instructions which are executed by the processor. The method may include the step of receiving, by the API curate module, a set of parameters from the one or more computing devices, the set of parameters pertaining to a predefined set of instructions associated with the plurality of APIs. Based on the received set of parameters, the method may include the step of arranging, by an API flow module, the plurality of APIs into one or more batches. In an embodiment, the API flow module may be associated with the processor. Furthermore, the method may include the step of displaying, by the API flow module, a single API from each batch to the user.

In an aspect, the present disclosure provides a user equipment (UE) for facilitating management of a plurality of application programming interfaces (API). The UE may include an edge processor and a receiver, the edge processor being coupled to one or more computing devices in a network. The edge processor may be further coupled with a memory that stores instructions which when executed by the edge processor may cause the UE to receive, by an API curate module, a plurality of APIs from the one or more computing devices. In an embodiment, the API curate module may be associated with the processor. The UE may be further configured to receive, by the API curate module, a set of parameters from the one or more computing devices, the set of parameters pertaining to a predefined set of instructions associated with the plurality of APIs. Based on the received set of parameters, the UE may arrange, by an API flow module, the plurality of APIs into one or more batches. In an embodiment, the API flow module may be associated with the processor and, display, by the API flow module, a single API from each batch to the user.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 that illustrates an exemplary network architecture in which or with which the system (110) of the present disclosure can be implemented, in accordance with an embodiment of the present disclosure.

FIG. 2A illustrates an exemplary representation of the system (110) for API management, in accordance with an embodiment of the present disclosure.

FIG. 2B illustrates an exemplary representation of the user equipment (108) for API management, in accordance with an embodiment of the present disclosure.

FIG. 2C illustrates an exemplary method flow diagram for API management, in accordance with an embodiment of the present disclosure.

FIG. 3 illustrates an exemplary representation of a high-level architecture of the API management system in accordance with an embodiment of the present disclosure.

FIG. 4 illustrates an exemplary representation of a high-level method flow diagram for process creation of the API flow module, in accordance with an embodiment of the present disclosure.

FIG. 5 illustrates an exemplary representation of a high-level method flow diagram for creation of trigger of the API flow module, in accordance with an embodiment of the present disclosure.

FIG. 6 illustrates an exemplary representation of a high-level method flow diagram for execution of the process of the API flow module, in accordance with an embodiment of the present disclosure.

FIG. 7 illustrates an exemplary representation of a high-level method flow diagram for analysing execution history of the API flow module, in accordance with an embodiment of the present disclosure.

FIG. 8 illustrates an exemplary representation of a high-level method flow diagram of deploying an API module in an API curate module, in accordance with an embodiment of the present disclosure.

FIG. 9 illustrates an exemplary representation of a high-level method flow diagram of viewing deployed API in an API curate module, in accordance with an embodiment of the present disclosure.

FIG. 10 illustrates an exemplary representation of a high-level method flow diagram for an API console module, in accordance with an embodiment of the present disclosure.

FIG. 11 illustrates an exemplary representation of a high-level method flow diagram process creation of the API flow module, in accordance with an embodiment of the present disclosure.

FIG. 12 illustrates an exemplary representation of a high-level method flow diagram for API Marketplace, overall Flow, in accordance with an embodiment of the present disclosure.

FIG. 13 illustrates an exemplary representation of a high-level method flow diagram execution flow of the API marketplace, in accordance with an embodiment of the present disclosure.

FIG. 14 illustrates an exemplary representation of a high-level method flow diagram dashboard flow of the API marketplace, in accordance with an embodiment of the present disclosure.

FIG. 15 illustrates an exemplary computer system in which or with which embodiments of the present invention can be utilized in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present invention provides a robust and effective solution to an entity or an organization by developing a complete suite for management of multiple APIs with governing factors such as documentation, execution, flow batching of APIs, along with onboarding new APIs and creating a competitive marketplace for APIs.

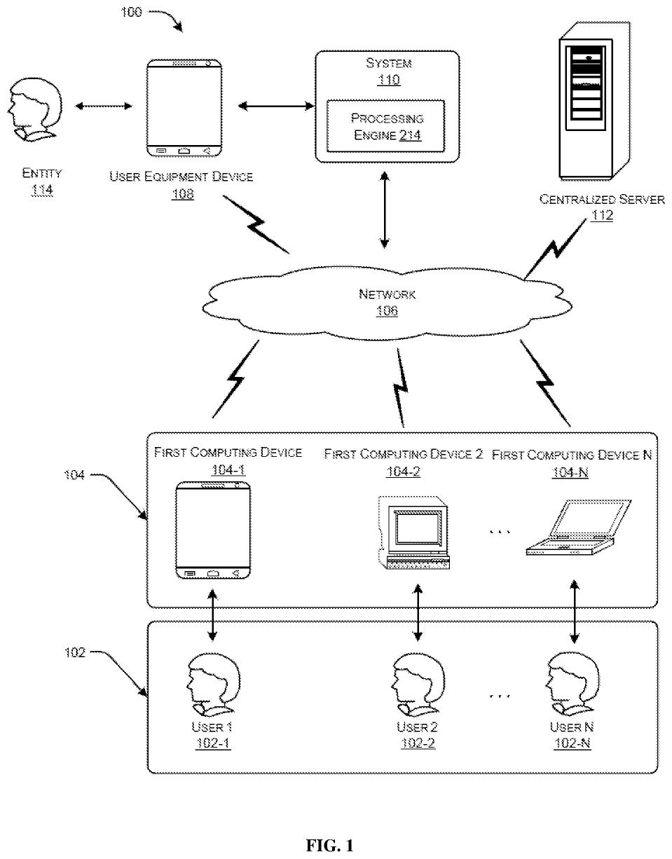

Referring to FIG. 1 that illustrates an exemplary network architecture (100) in which or with which API management system (110) (interchangeably referred of the present disclosure can be implemented, in accordance with an embodiment of the present disclosure. As illustrated, the exemplary architecture (100) includes one or more communicably coupled computing devices (104-1, 104-2, . . . 104-N) (also referred to as machines herein) that communicate across a network (106) (note that although only network 106 connections have been labelled in FIG. 1, one or more of the other indicated connections between components can also be considered part of network 106).

In some implementations, the system (110) or portions of the system (110) can operate within a cloud-computing-based environment associated with a centralized server (112). As an example, and not by way of limitation, the user computing device (104) may be operatively coupled to the centralized server (112) through the network (106) and may be associated with the entity (114). Examples of the user computing devices (104) can include, but are not limited to a smart phone, a portable computer, a personal digital assistant, a handheld phone and the like.

The system (110) may further be operatively coupled to a second computing device (108) (also referred to as the user computing device or user equipment (UE) hereinafter) associated with the entity (114). The entity (114) may include a company, a hospital, an organisation, a university, a lab facility, a business enterprise, or any other secured facility that may require features associated with a plurality of API. In some implementations, the system (110) may also be associated with the UE (108). The UE (108) can include a handheld device, a smart phone, a laptop, a palm top and the like. Further, the system (110) may also be communicatively coupled to the one or more first computing devices (104) via a communication network (106).

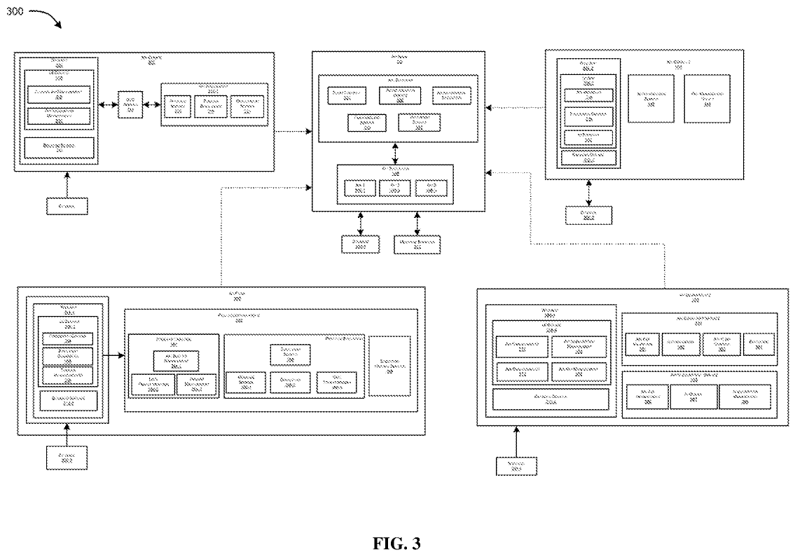

The illustrated system (110) may be equipped with a processing engine (208) that may be coupled to an API curate module (302) (ref. FIG. 3), an), an API console module (334), an API marketplace module (370), an API bank (322) and API Flow module (360). The system (110) may receive, by an API curate module (302), a plurality of APIs from the one or more computing devices (104) and receive, by the API curate module (302), a set of parameters from the one or more computing devices (104), the set of parameters pertaining to a predefined set of instructions associated with the plurality of APIs. Based on the received set of parameters, arrange, by an API flow module (360), the plurality of APIs into one or more batches and then display, by the API flow module (360), a single API from each batch to the user.

As stated above, the API flow module (360), is any device or program communicably coupled with the API management system (particularly through an API gateway) that batches a plurality of APIs as a process and expose a single API to a user. The user can create custom solutions consuming the plurality of APIs executing parallelly or sequentially and expose as a single entity to run. The plurality of APIs onboarded via API curate and enabled by a developer can be used for API Flow automatically. The API Curate module (302) may be a device or a program or a self-service portal to onboard a new API into the ecosystem via a defined process. The process accepts details related to the interactive documentation modules, API Marketplace module, API Flow module and enabling different modes, SLA values for the API. The users can also submit request for a new API to be developed as per a development team.

In an exemplary embodiment, the API Console module (334) is an interactive documentation module for the plurality of APIs available in the API Bank (322). In another exemplary embodiment, the API Marketplace may provide monetization of APIs from API Bank with Pricing Subscription for internal BUs as well as external public within the entity. For example, end users can submit reviews, provide ratings, subscribe/unsubscribe to API for consumption. API Developer can set a pricing Model for different SLA usage of their APIs.

The described illustration is only one possible implementation of the described subject matter and is not intended to limit the disclosure to the single described implementation. Those of ordinary skill will appreciate the fact that the described components can be connected, combined, and used in alternative ways consistent with this disclosure.

In some implementations, the API flow module (360) consumes an API like a simple object access protocol (SOAP) service or an open data protocol (ODATA) service. Open Data Protocol (OData) is a generic web protocol for querying and updating data over networks and allows for a user to request data from a data source over the Hypertext Transfer Protocol and receive results back from the data source in OData format or other formats such as Atom Publishing Protocol (Atom), JAVASCRIPT Object Notation (JSON), and Extensible Markup Language (XML), etc. The OData protocol is increasingly used by mobile computing and other computing platforms, such as smartphones and tablet computers, as an important method of access to information over networks. As will be appreciated by those skilled in the art, the use of OData, HTTP(S), RFC, XML/JSON, and the like can be substituted for other protocols, computer languages, etc. The exemplary use of a protocol, computer language, etc. in this disclosure is not meant to be limiting in any way. Other appropriately formatted requests in any protocol and/or computer language are also considered to be within this scope of this disclosure.

The API flow module (360) can technically be a server or client depending on the initiation of a specific API request and may manage the plurality of APIs at a single place.

In an exemplary embodiment, the API console module may display information related to use cases, how to use, variants of an API in easy to read and consumable format. This belongs to all the APIs currently present in execution.

In another exemplary embodiment, the API curate module may provide a process oriented onboarding of new APIs into the system and has a portal to add new APIs into the ecosystem and enabling it with execution with all other components such as interactive documentation, batching of APIs, marketplace of APIs, as well as synchronous and asynchronous execution but not limited to the like.

In an exemplary embodiment, the system (110) may develop custom solutions consuming one or more APIs, chaining the one or more APIs as flow, sequential or parallel and exposing the complete solution as a single API.

In an exemplary embodiment, the system (110) may execute APIs from different places are executed on single platform. Common considerations about Rate limiting, authentication, different protocols interface and different modes of execution such as synchronous and asynchronous are taken care by API M Suite and a developer need not to worry about it.

In an exemplary embodiment, the system (110) may provide a single place management of APIs existing into an enterprise from onboarding, execution, interactive documentation, batching or flow generation to a marketplace.

In an exemplary embodiment, the system (110) may be configured for providing automatic authentication, rate limiting, asynchronous or synchronous execution but not limited to the like.

In an exemplary embodiment, the system (110) may be provided with a graphical user interface (GUI) to provide easy and interactive interface for first users (interchangeably referred to as producers) and second users (interchangeably referred to as consumers). In an exemplary embodiment, the producers and consumers can publish or subscribe to an API with SLA, pricing, specified by the producer. The consumer can also look at ratings, reviews of the API and choose to subscribe form multiple options of other APIs.

In an exemplary embodiment, the system (110) may be configured for providing a display module having interfaces that provides textual, visual description containing Images, formulae, a plurality of fonts of formatting for all of the APIS.

In an exemplary embodiment, the system (110) may provide input output (IO) format of the API in Both JSON and Protocol Buffers but not limited to the like.

In an exemplary embodiment, the system (110) may reside within a user equipment (UE).

In an embodiment, the one or more computing devices (104) and the UE may communicate with the system (110) via set of executable instructions residing on any operating system, including but not limited to, Android™, iOS™, Kai OS™ and the like. In an embodiment, to one or more computing devices (104), may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen, receiving devices for receiving any audio or visual signal in any range of frequencies and transmitting devices that can transmit any audio or visual signal in any range of frequencies. It may be appreciated that the to one or more computing devices (104) and the UE may not be restricted to the mentioned devices and various other devices may be used. A smart computing device may be one of the appropriate systems for storing data and other private/sensitive information.

In an embodiment, the system (110) may include a processor coupled with a memory, wherein the memory may store instructions which when executed by the one or more processors may cause the system to access content stored in a network.

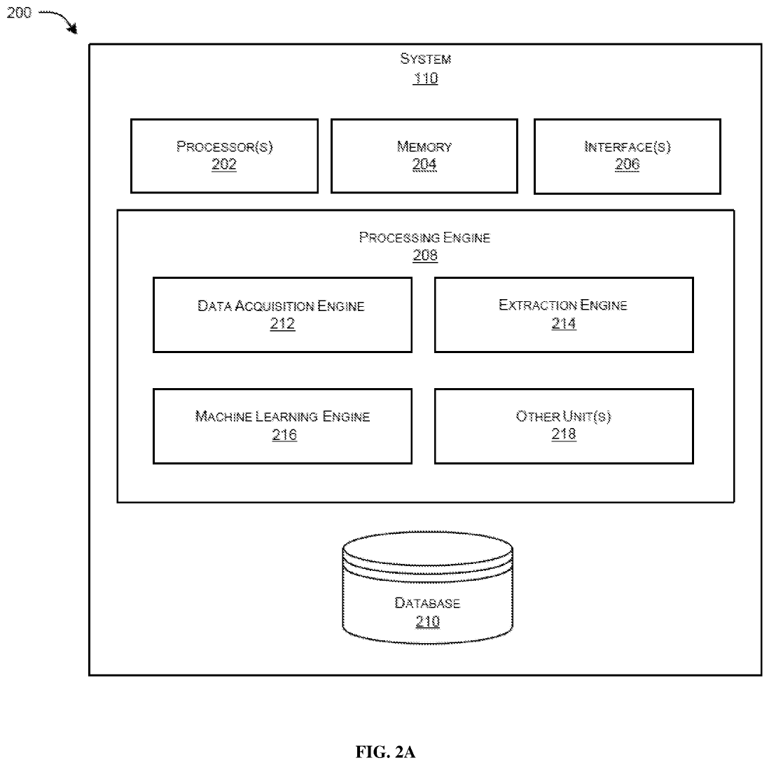

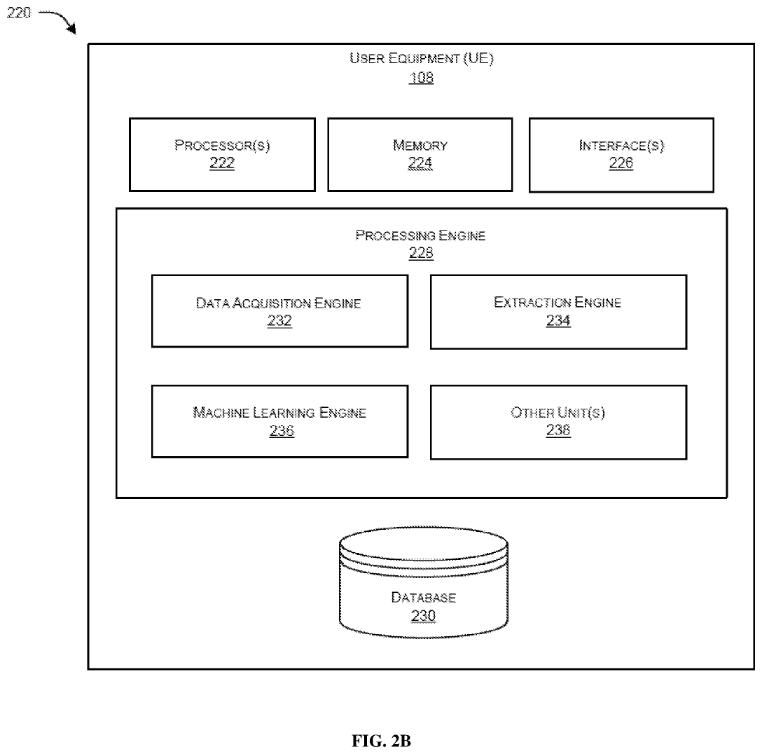

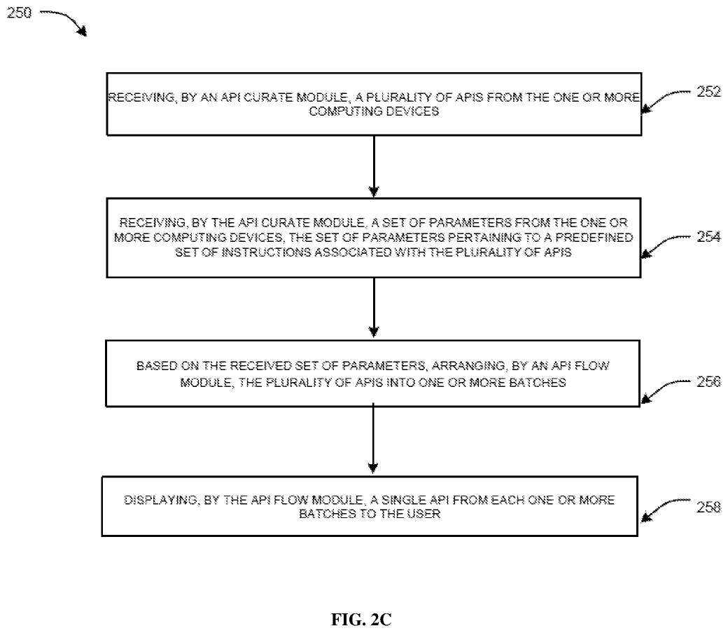

FIG. 2A with reference to FIG. 1, illustrates an exemplary representation of system (110) for facilitating scheduling of APIs, in accordance with an embodiment of the present disclosure. In an aspect, the system (110) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) 206 may comprise a variety of interfaces, for example, interfaces for data input and output devices, referred to as I/O devices, storage devices, and the like. The interface(s) 206 may facilitate communication of the system (110). The interface(s) 204 may also provide a communication pathway for one or more components of the system (110). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a data acquisition engine (212), an extraction engine (214), a machine learning (ML) engine (216), and other engines (218). The processing engine (208) may further include an API curate module, API flow module, API console module, API marketplace.

FIG. 2B illustrates an exemplary representation (220) of the user equipment (UE) (108), in accordance with an embodiment of the present disclosure. In an aspect, the UE (108) may comprise an edge processor (222). The edge processor (222) may be implemented as one or more microprocessors, microcomputers, microcontrollers, digital signal processors, central processing units, logic circuitries, and/or any devices that process data based on operational instructions. Among other capabilities, the edge processor(s) (222) may be configured to fetch and execute computer-readable instructions stored in a memory (224) of the UE (108). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (108) may include an interface(s) 226. The interface(s) 206 may comprise a variety of interfaces, for example, interfaces for data input and output devices, referred to as I/O devices, storage devices, and the like. The interface(s) 206 may facilitate communication of the UE (108). Examples of such components include, but are not limited to, processing engine(s) 228 and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (228) may be implemented by electronic circuitry.

The processing engine (228) may include one or more engines selected from any of a data acquisition engine (232), an extraction engine (234), a machine learning (ML) engine (236), and other engines (238). The processing engine (228) may further include an API curate module, API flow module, API console module, API marketplace.

FIG. 2C illustrates an exemplary representation of the proposed method (250) for optimizing and scheduling APIs, in accordance with an embodiment of the present disclosure. The method (250) may include at 252, the step of receiving, by an API curate module (302), a plurality of APIs from the one or more computing devices. The method (250) may include at 252 the step of receiving, by the API curate module (302), a set of parameters from the one or more computing devices, the set of parameters pertaining to a predefined set of instructions associated with the plurality of APIs. Based on the received set of parameters, the method (250) may include at 256, the step of arranging, by an API flow module (360), the plurality of APIs into one or more batches. Furthermore, the method (250) may include at 258, the step of displaying, by the API flow module (360), a single API from each one or more batches to the user.

FIG. 3 illustrates an exemplary representation of a high level architecture of the API management system in accordance with an embodiment of the present disclosure. As illustrated, in an aspect, the proposed system may include an API management suite (300). The API management suite may include an API Curate (302). The API Curate is a self-service onboarding application that lets API development teams publish APIs into the API Bank. Onboarding APIs within the API Management Suite can help developers use the standard prebuild services of APIM such as Authentication, Flow control, Modes of execution, Caching. Thus enables the developer to easily add the additional layers on legacy APIs. The users can even also request for a custom API to be built for a specific use case. The newly onboarded API will be made visible to all other components such as Interactive Dashboard (API Console), API Flow and API Marketplace. The details related to specific section is captured during onboarding APIs into the system.

In an exemplary embodiment, the API Curate (302) components may include an onboard custom API (308). The onboard custom API (308) enables the user to expose a custom API into the API Management Suite (300) of API Bank. The user needs to provide SVN location, authentication details within a sample template. The system runs a pipeline to build code, run validation tests and deploy the application on API Bank machines. The user needs to provide meta information regarding API Console (Interactive Dashboard) such as Rich text Description, Category of API, IO Format Samples and Driver code in various languages.

The API curate (302) may further include a dashboard that can tell the user about the APIs exposed in the API management suite with status as deployed or recalled. The user can change the source git location, manually re deploy the application. The user can edit the meta information details (Interactive Dashboard) related to API. The user can submit a request along with a requirements document to create a custom API for a use case. The request can be fulfilled by the internal team of API Management Suite.

The API curate (302) may further include API integration management (310), backend service (312), an SVC service (314), an API integrator (310-1) that may further include build service (316), publish build image (318) and a development service (320).

In an exemplary embodiment, the API management suite (300) may include an API Console (334). The API Console (334) is an interactive dashboard for all the APIs in an API Bank (322). This enables all API develops a ready documentation page explaining how the API can be consumed. This helps in standardization of documentation process. The dashboard shows all the APIs by category along with additional information for each API such as: rich text description that may describe the API in detail with graphical images, formatted text and scientific equations (336). IO Formats (340). Each API can be having different protocols of execution; Hence it shows the Input and Output formats for an API for each interface of execution. For example: JSON Messages for Rest, and Protocol buffer messages for GRPC. The API console may include Driver Codes. It shows the implementation codes in various programming languages for the API. The default mode of execution is synchronous mode, section also shows additional settings to make the API execute in asynchronous mode if applicable. The API console (334) may include an authentication service (342) that further may include an API Key Generation. A developer (free) API key may be generated when the user is authenticated with AD. The key enables to try out the API with the sample driver code and IO Formats in execution from API Bank.

The API console (344) may include a file management service (344) may include user specific files. The user can upload a file which is an input for specific set of APIs. This enables the API to have the file already available on server and user has no need to send the file in every request The user can download files generated after execution of an API as result. The download able link is shared in response of API and can be downloaded from Files section for a later stage.

The API management suite (300) may include the API Bank (322) which is the main execution component of API Management suite where all APIs in execution are deployed. Some common modules layer which stands in front of all set of APIs deployed such as authentication (326), flow control (324), caching, different protocols and modes of execution (328). The APIs can be executed using Rest and GPRC protocols, and with synchronous and asynchronous mode of execution. This enables the API developers to focus on core business logic and not worry about common practices to make API productionized. During execution of an API, the common layer captures basic metrics like request origin, rate of request, size of data, protocol, resource requested. A user needs to gain an authentication token Free from message brokers (352) or via Marketplace to consume the API.

The API management suite (300) may include an API Flow (360). The API Flow may take care batching of API calls from API Bank to group sequential or parallel API calls in a process. There can be multiple cases related to API batching that may include transform data between API calls, call an external API from internet and consume in the flow, Save the batching (process) to run later and trigger a process synchronously or asynchronously multiple times via HTTP. The main components of API Flow may include process creation (364) that may provide a Canvas where user creates a flow of APIs connected together and expose the process as a single meta-API for execution, the user can place blocks of APIs from API Bank (All the APIs deployed), Data Transformation blocks (364-2) (change data format after executing API from previous block into another format for next block), execute an external API (366) (external API and pass output to next block).

The API flow (360) may include trigger management (364-3). The triggers are endpoints over HTTP Channel to start a Process in execution created by user. The user can fire the Triggers via any HTTP Client and the processes mapped to it are executed. The user gets a transaction id for an asynchronous process and the result of end block of process if it's a sync process. The triggers provide interface between process and the way to execute it. The Dashboard (304) shows the history of execution of processed to the user. Initially a list with execution identifier, process start and duration time and result of recently executed processes are shown to the user. The user can get detailed logs at each stage to debug when expanded a previous execution.

The API management suite (300) may further include an API Marketplace (370) that enables productionize existing APIs from the API Bank (322). Internal teams within an entity may productionize the APIs through the API marketplace (370) which can be used by other entities or even exposed to public. The producers of an API can submit interest for monetizing with a pricing subscription for various factors such as rate usage. The API Marketplace (370) can take custom APIs as well for monetization/productionization. The consumer of the API can subscribe to an API, provide reviews and ratings as well which creates a competitive environment around the APIs and fosters innovation.

In an exemplary embodiment, the main components an API catalogue: that displays the list of all the available APIs form API Bank for monetization. The user sees the APIs segregated by categories, can view ratings, reviews for the API given by other developers, a “verified” tick meaning the API is validated by internal API Management Team, and a rich text description for marketing about the API. The user can even view the various pricing plans for different rate limits or SLAs.

The API marketplace (370) may further include an API Subscription Module (374) where an API consumer can select a pricing plan for an API of interest and subscribe to it. Once the subscription is successful, the consumer gets an “API Key” from an API key management module (378) which maps to the subscription selection by the consumer. The Consumer may have to use the API key during each call for execution of API. The API Key is used to authorize the caller against the subscription plan and then forwards the request to API Bank for execution.

The API marketplace (370) may include a Dashboard (372) that shows the logged in user the list of all the APIs subscribed. The User can go to the API Key Management module (378), where the keys are can be managed such as re generated, disabled for execution. The user gets to check the usage quotas for an API subscribed. The user can set alerts such as email messages if the rate limit quotas exceed a threshold

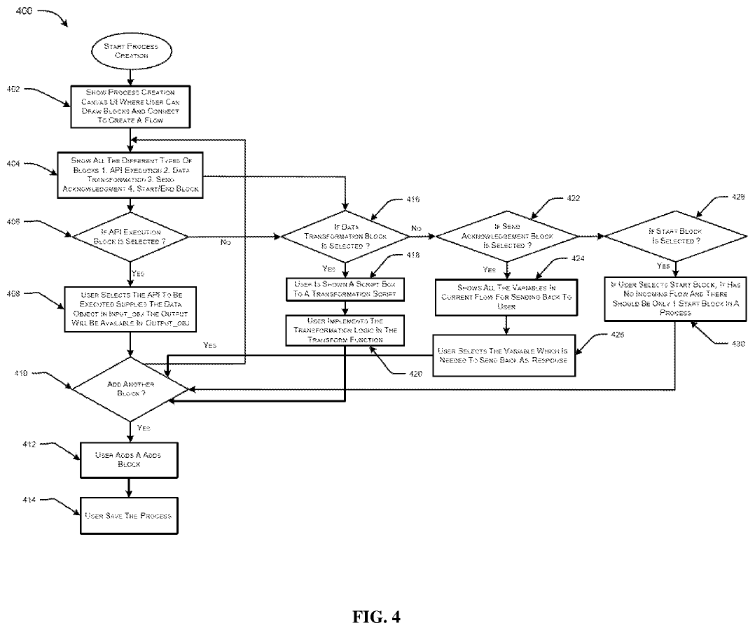

FIG. 4 illustrates an exemplary representation of a high-level method flow diagram process creation of the API flow module, in accordance with an embodiment of the present disclosure.

As illustrated, in an embodiment, the method (400) may include at 402 a Canvas where user creates a flow of APIs connected together and expose the process as a single meta-API for execution and at 404, the user can place blocks of APIs from API Bank (All the APIs deployed). The method may also include the steps of 414, 416, 418 having Data Transformation blocks where change of data format after executing API from previous block into another format for next block at steps 406, 408, 410 and 412. The method (400) may further include execution of an external API where external API and pass output to the next block.

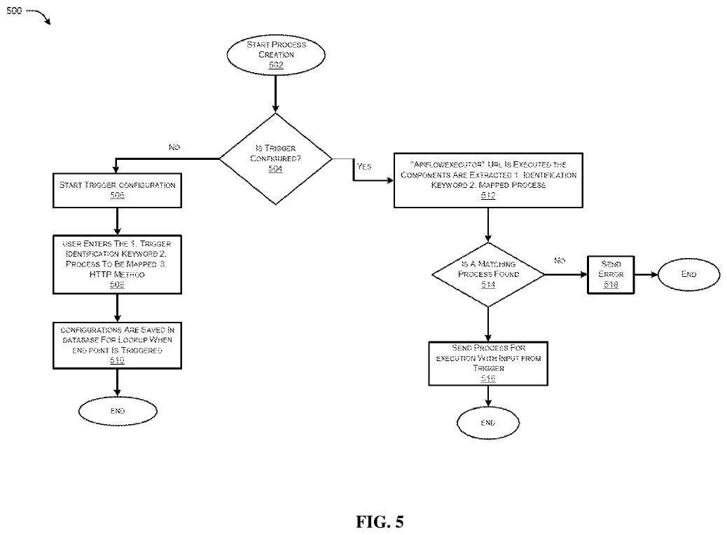

FIG. 5 illustrates an exemplary representation of a high-level method flow diagram for creation of trigger of the API flow module, in accordance with an embodiment of the present disclosure. As illustrated, in an embodiment, triggers are endpoints over HTTP Channel to start a Process in execution created by the user. The method may include at 502 and 504 configuration of triggering the endpoints. If trigger has not been configured at 506, at 508, the user enters a plurality of details. The configuration details may be saved in a database at 510. If the trigger is configured then at 512, API Flow executer url may be executed and at 514, 516, the User can fire the Triggers via any HTTP Client and the processes mapped to it are executed.

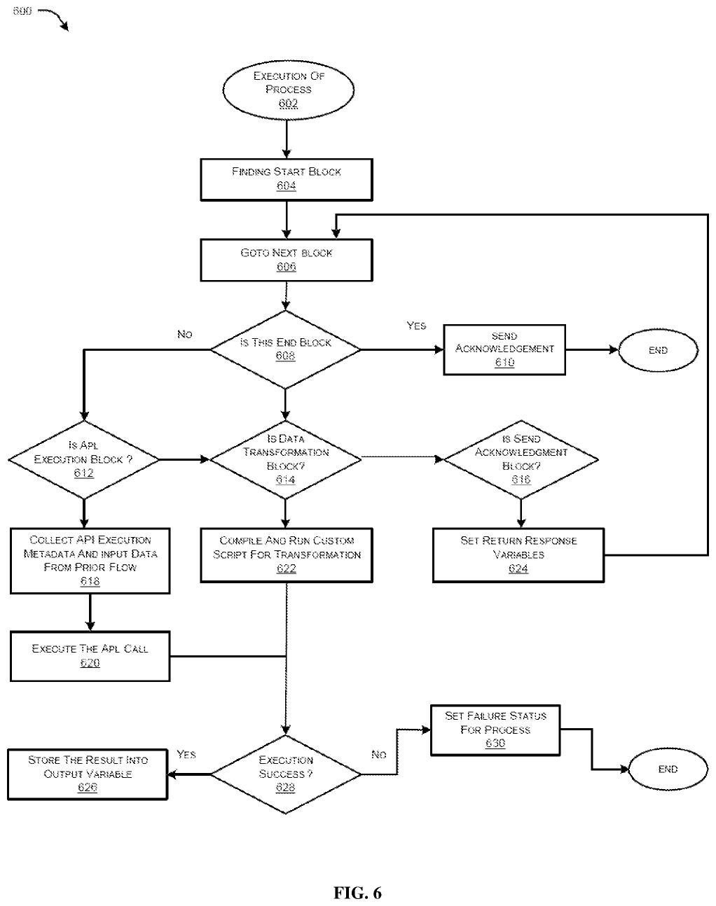

FIG. 6 illustrates an exemplary representation of a high-level method flow diagram for execution of the process of the API flow module, in accordance with an embodiment of the present disclosure. As illustrated, the user gets a transaction id for an asynchronous process and the result of end block of process if it's a sync process that may comprise of finding start block 604, checking if it is an end block at 606, and going to end block at 608 and sending an acknowledgement if it is an end block at 610. If it is not an end block, then the method checks for data transformation block at 614 and send acknowledgement block at 616 and accordingly performs the functions of execution through steps 618 to 630. Triggers provide interface between process and the way to execute it.

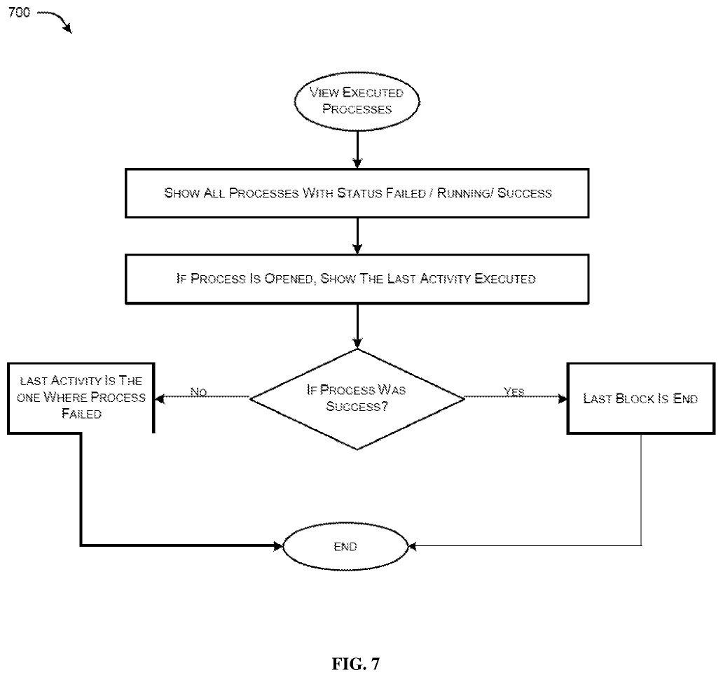

FIG. 7 illustrates an exemplary representation of a high-level method flow diagram for analysing execution history of the API flow module, in accordance with an embodiment of the present disclosure. As illustrated, dashboard shows the history of execution of processed to the user. Initially a list with execution identifier, process start and duration time and result of recently executed processes are shown to user. The user can get detailed logs at each stage to debug when expanded a previous execution. For example, at 702, the executed processes may be checked and show all processes with each kind of status at 704. If the process is opened at 706, then show the last activity executed. If the process was successful at 708, then last block is end block at 712. If the process was not successful, then the last activity is the one where the process failed.

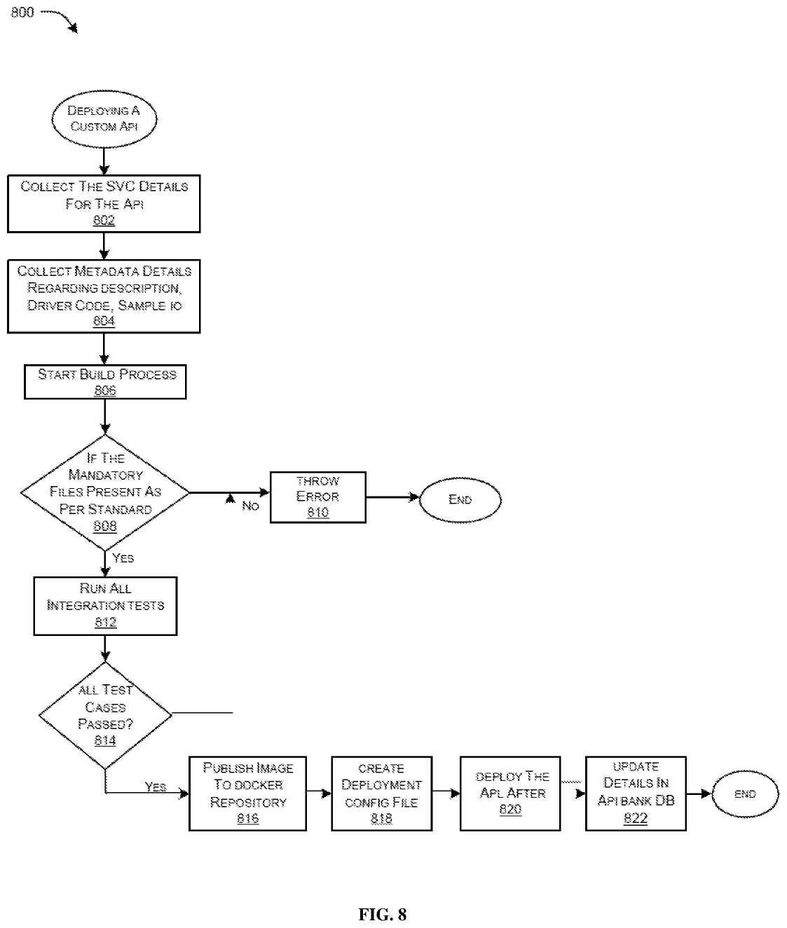

FIG. 8 illustrates an exemplary representation of a high-level method flow diagram of deploying an API module in an API curate module, in accordance with an embodiment of the present disclosure. As illustrated, expose custom API in the API Management suite which supports a predefined deployment template. The API can be executed along with other APIs in API Bank. Custom APIs documentation will be visible in API Console. Custom API can be used as an API in execution in API Flow. To register, user can provide a SVC repo link, from where the latest code is taken for build, running tests and finally deployment in execution machines. A Dashboard provides the user a list of services deployed by user along with management activities to redeploy, stop, delete. For example, for deploying a custom API, at 802, collect the SVC details for the API and at 804, collect metadata details and then start building process at 806. If mandatory files are present as per standard at 808, then run all integration tests at 812 and check for all test cases passed at 814. If all tests are passed, then at 816 publish image at docker repository, at 818, create deployment configuration file, at 820, deploy the API and at 822, update API details in the database. If any or a combination of mandatory files are not present as per standard and if all tests are not passed, then at 810, an error is thrown.

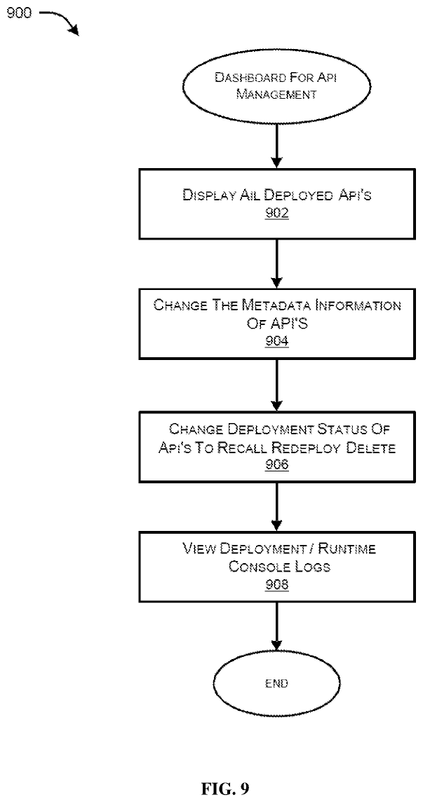

FIG. 9 illustrates an exemplary representation of a high level method flow diagram of viewing deployed API in an API curate module, in accordance with an embodiment of the present disclosure. As illustrated, at 902, all deployed API are displayed in the API dashboard, at 904, change the metadata information of APIs and at 906, change deployment status of the API. At 908, view run time deployment logs.

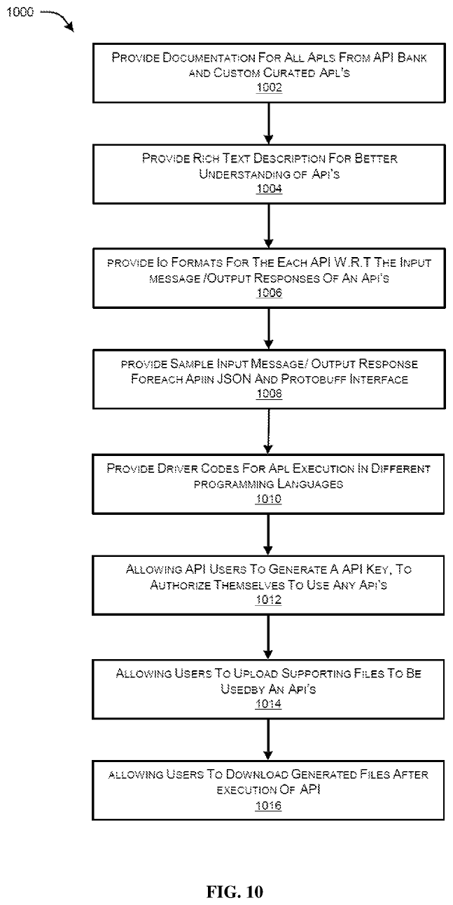

FIG. 10 illustrates an exemplary representation of a high level method flow diagram for an API console module, in accordance with an embodiment of the present disclosure. In an exemplary embodiment, the API console, at 1002, provides documentation, at 1004 provide rich text description, displays metadata about API's such as description, Sample IO format at 1006, Driver codes in curl and Python at 1010, generates an API Key at 1012 used to execute APIs from Bank Provides utility for File Handling use cases such file as input/download generated files and modules back to the user at steps 1014, 1016.

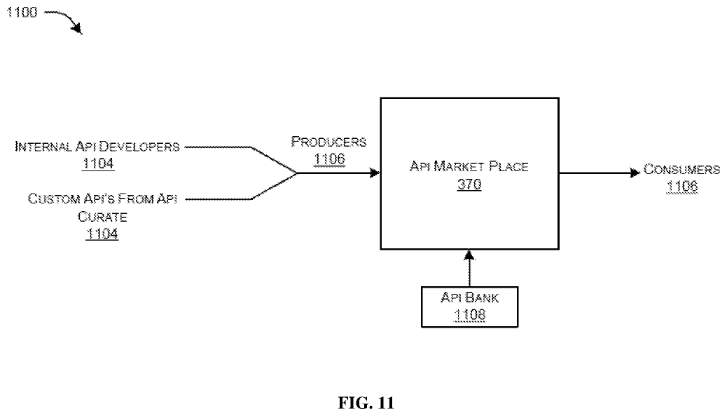

FIG. 11 illustrates an exemplary representation of a high level block diagram of an API marketplace module, in accordance with an embodiment of the present disclosure. As illustrated, the developers from API Curate 1102 or internal teams can publish APIs on the API Marketplace 370 for consumers at 1110. The APIs have additional User specific ratings, Reviews, License's pricing and rate usage limits. The consumers 1110 can subscribe to APIs with a generated API Key. The API key acts as authentication and authorization of usage of APIs with the agreed set of features such as rate limiting, mode of execution and the like. the API keys can be managed (regenerated, assigned to different APIs, same API with different authorization mechanisms for example at least 5 requests/day but not limited to the like.

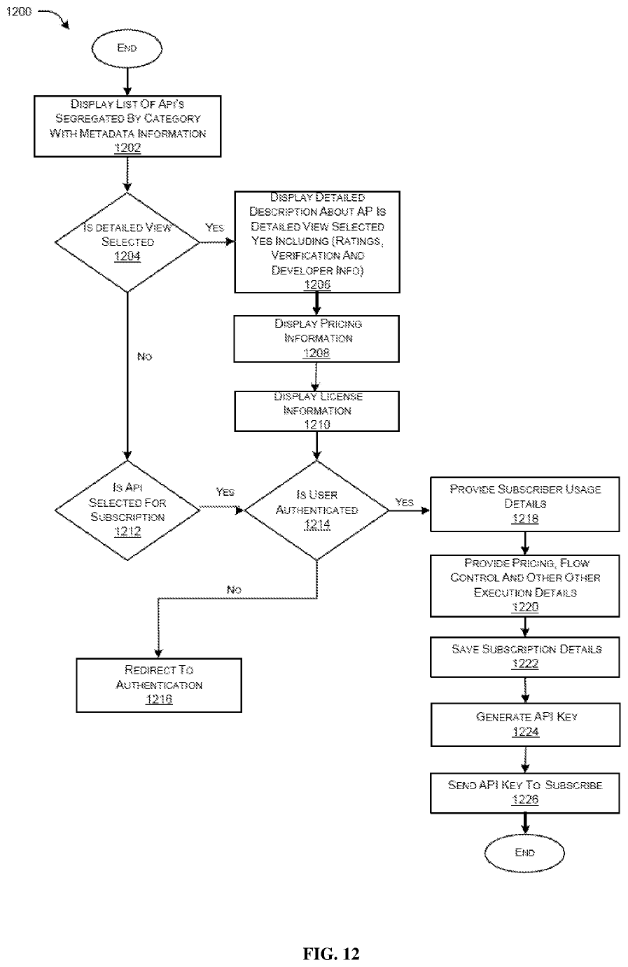

FIG. 12 illustrates an exemplary representation of a high level method flow diagram for API Marketplace, overall Flow, in accordance with an embodiment of the present disclosure. As illustrated, display list of APIs segregated by category with metadata information at 1202, if detailed view is selected at 1204, display detailed description about API at 1206, display pricing information at 1208, display license information 1210. At 1212, if API is selected for subscription then at 1214, if the user is authenticated, at 1218, provide subscriber usage details, provide pricing at 1220, save subscription details at 1222, generate API key at 1224 and then send the API key to the subscriber at 1226.

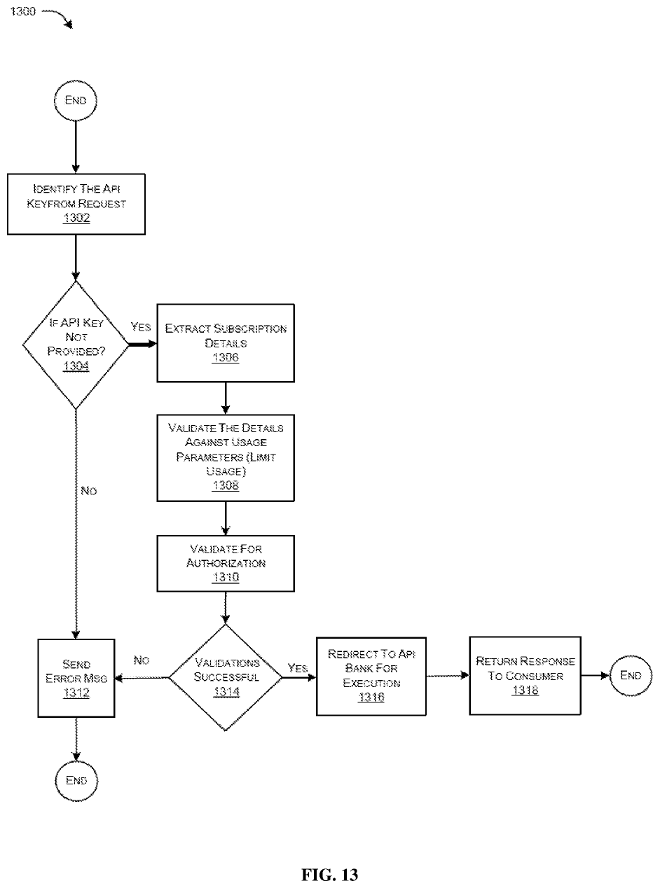

FIG. 13 illustrates an exemplary representation of a high level method flow diagram execution flow of the API marketplace, in accordance with an embodiment of the present disclosure. As illustrated, at 1302, identify the API key from request, If an API key is not provided at 1304, at 1306, extract subscription details and at 1308, validate the details against the usage parameters and then at 1310, validate for authorization. If at 1314, the validations are successful, redirect to API for bank execution at 1316 and at 1318, return response to consumer. If any discrepancy arises in the steps, then at 1312, send error message.

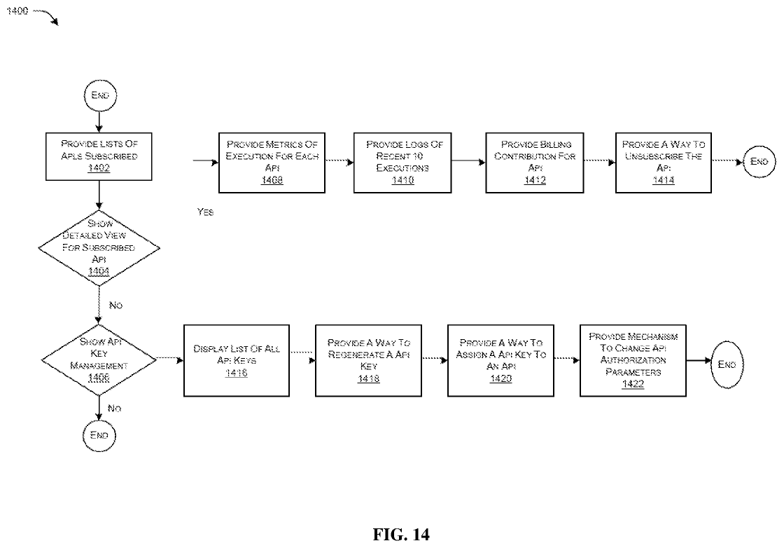

FIG. 14 illustrates an exemplary representation of a high level method flow diagram dashboard flow of the API marketplace, in accordance with an embodiment of the present disclosure. As illustrated, at 1402, provide lists of APIs subscribes and then show at 1404, detailed view for subscribed API, at 1408, provide metrics of execution for each API, at 1410 provide logs of recent 10 executions, at 1412, provide billing contribution for API and at 1414, provide a way to unsubscribe the API. If detailed view of the API is not viewed at 1404, then at 1406, show API key management. At 1416, display list of all API keys. At 1418, provide a way to regenerate an API key and then at 1420, provide a way to assign an API key to an API and at 1422 provide a mechanism to change API authorization parameters.

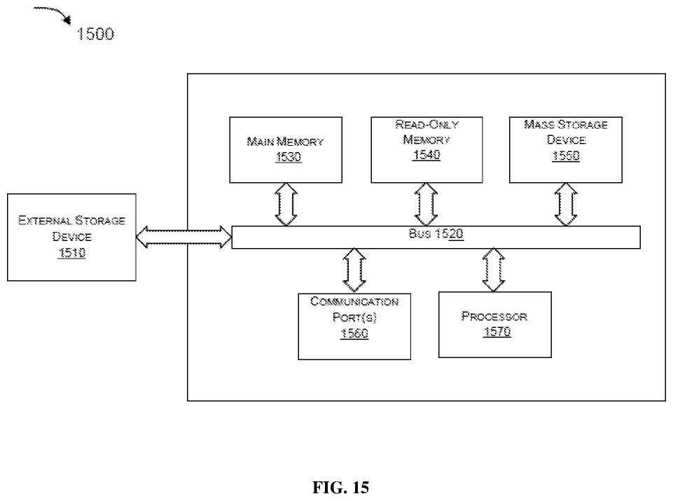

FIG. 15 illustrates an exemplary computer system in which or with which embodiments of the present invention can be utilized in accordance with embodiments of the present disclosure. As shown in FIG. 15, computer system 1500 can include an external storage device 1510, a bus 1520, a main memory 1530, a read only memory 1540, a mass storage device 1550, communication port 1560, and a processor 1570. A person skilled in the art will appreciate that the computer system may include more than one processor and communication ports. Processor 15150 may include various modules associated with embodiments of the present invention. Communication port 1560 may be chosen depending on a network, or any network to which computer system connects. Memory 1530 can be Random Access Memory (RAM), or any other dynamic storage device commonly known in the art. Read-only memory 1540 can be any static storage device(s). Mass storage 1550 may be any current or future mass storage solution, which can be used to store information and/or instructions.

Bus 1520 communicatively couples processor(s) 1570 with the other memory, storage and communication blocks. Bus 1520 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 15150 to software system.

Optionally, operator and administrative interfaces, e.g. a display, keyboard, and a cursor control device, may also be coupled to bus 1520 to support direct operator interaction with a computer system. Other operator and administrative interfaces can be provided through network connections connected through communication port 1560. Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### Advantages of the Present Disclosure

The present disclosure provides for an interactive documentation, a place which displays information related to use cases, how to use variants of an API in an easy to read and consumable format.

The present disclosure provides for a process-oriented platform for onboarding new APIs into the system.

The present disclosure provides for a portal to add new APIs into the ecosystem and enabling it with execution with all other components.

The present disclosure provides for custom solutions for consuming one or more multiple APIs, chaining them as flow, sequentially or parallelly and exposing the complete solution as a single API.

The present disclosure provides for a platform that can act as a marketplace for all the existing APIs in the bank.

The present disclosure provides for a platform to end users to submit reviews, provide ratings, subscribe/unsubscribe to API for consumption.

The present disclosure provides for a system and method that can execute APIs from different places are executed on single platform.

The present disclosure provides for a system and method that can take care of common considerations about rate limiting factors, authentication factors, different protocol interfaces and different modes of execution such as synchronous and asynchronous so that a developer need not worry about those.

We claim:

1. A system (110) for facilitating scheduling of a plurality of application programming interfaces (API), the system (110) comprising:
a processor (202) coupled to one or more computing devices (104) in a network (106), wherein the processor (202) is further coupled with a memory (204), wherein said memory stores instructions which when executed by the processor (202) causes the system (110) to:
receive, by an API curate module (302), a plurality of APIs from the one or more computing devices (104), wherein the API curate module (302) is associated with the processor (202);
receive, by the API curate module (302), a set of parameters from the one or more computing devices (104), the set of parameters pertaining to a predefined set of instructions associated with the plurality of APIs;
based on the received set of parameters, arrange, by an API flow module (360), the plurality of APIs into one or more batches, wherein the API flow module (360) is associated with the processor (202); and,
display, by the API flow module (360), a single API from batch to the user.

2. The system (110) as claimed in claim 1, wherein the system is further configured to
create, by the API flow module (360), one or more custom solutions for the plurality of APIs executing parallelly or sequentially;
execute, by the API flow module (360), the plurality of APIs in a single platform.

3. The system as claimed in claim 1, wherein the system is further configured to onboard, by the API curate module (302), a new API based on a predefined set of instructions.

4. The system as claimed in claim 1, wherein the system is further configured to determine a cumulative service level agreement (SLA) of each API applicable for each computing device (104).

5. The system as claimed in claim 1, wherein the system is further configured to store the plurality of APIs, the new API and one or more deployed APIs from the one or more batched in an API Bank (322).

6. The system as claimed in claim 1, wherein the system is further configured to receive one or more details associated with one or more interactive documentation, one or more marketplace documentation, API flows, a plurality of modes and the SLAs associated with the plurality of APIs and the new API.

7. The system as claimed in claim 1, wherein the system is further configured to manage the one or more details associated with the one or more interactive documentation, the one or more marketplace documentation, the API flows, the plurality of modes, the SLAs associated with the plurality of APIs and the new API.

8. The system as claimed in claim 1, wherein the system is further configured to receive a request from a user computing device for a new API to be developed.

9. The system as claimed in claim 1, wherein the system is configured to store in an API console the one or more interactive documentation.

10. The system as claimed in claim 1, wherein the system is configured to execute, by an API Management Suite (300), the plurality of APIs as a flow synchronously, asynchronously, sequentially or parallelly as a single API, wherein the API Management Suite (300) is associated with the processor (202).

11. The system as claimed in claim 1, wherein the system is configured to receive, by the API Management Suite (300), reviews, ratings, subscriptions for API consumption from the one or more computing devices associated with one or more users.

12. The system as claimed in claim 1, wherein the system is configured to authenticate, by the API Management Suite (300), the plurality of APIs.

13. A method for facilitating scheduling of a plurality of application programming interfaces (API), the method comprising:
receiving, by an API curate module (302), a plurality of APIs from the one or more computing devices (104), wherein the API curate module (302) is associated with a processor (202), the processor (202) coupled to one or more computing devices (104) in a network (106), wherein the processor (202) is further coupled with a memory (204) that stores instructions which are executed by the processor (202);
receiving, by the API curate module (302), a set of parameters from the one or more computing devices (104), the set of parameters pertaining to a predefined set of instructions associated with the plurality of APIs;
based on the received set of parameters, arranging, by an API flow module (360), the plurality of APIs into one or more batches, wherein the API flow module (360) is associated with the processor (202); and,
displaying, by the API flow module (360), a single API from each batch to the user.

14. The method as claimed in claim 14, wherein the method comprises the steps of:
creating, by the API flow module (360), one or more custom solutions for the plurality of APIs executing parallelly or sequentially; and,
executing, by the API flow module (360), the plurality of APIs in a single platform.

15. The method as claimed in claim 14, wherein the method comprises the step of:
onboarding, by the API curate module (302), a new API based on a predefined set of instructions.

16. The method as claimed in claim 14, wherein the method comprises the steps of:
determining a cumulative service level agreement (SLA) of each API applicable for each computing device (104).

17. The method as claimed in claim 14, wherein the method comprises the steps of:
Storing, the plurality of APIs, the new API and one or more deployed APIs from the one or more batched in an API Bank (322).

18. The method as claimed in claim 14, wherein the method comprises the step of:
receiving one or more details associated with one or more interactive documentation, one or more marketplace documentation, API flows, a plurality of modes and the SLAs associated with the plurality of APIs and the new API.

19. The method as claimed in claim 14, wherein the method comprises the steps of:
managing the one or more details associated with the one or more interactive documentation, the one or more marketplace documentation, the API flows, the plurality of modes, the SLAs associated with the plurality of APIs and the new API.

20. The method as claimed in claim 14, wherein the method comprises the steps of:
receiving a request from a user computing device for a new API to be developed.

21. The method as claimed in claim 14, wherein the method comprises the steps of:
storing in an API console the one or more interactive documentation.

22. The method as claimed in claim 14, wherein the method comprises the steps of:
executing, by an API Management Suite (300), the plurality of APIs as a flow synchronously, asynchronously, sequentially or parallelly as a single API, wherein the API M Suite is associated with the processor;
receiving, by the API Management Suite (300), reviews, ratings, subscriptions for API consumption from the one or more computing devices associated with one or more users; and,
authenticating, by the API Management Suite (300), the plurality of APIs.

23. A user equipment (UE) for facilitating scheduling of a plurality of application programming interfaces (API), the UE comprising:
an edge processor (222) and a receiver, the edge processor being coupled to one or more computing devices (104) in a network (106), wherein the edge processor (222) is further coupled with a memory (204), wherein said memory stores instructions which when executed by the edge processor (222) causes the UE to:
receive, by an API curate module (302), a plurality of APIs from the one or more computing devices (104), wherein the API curate module (302) is associated with the edge processor (222);
receive, by the API curate module (302), a set of parameters from the one or more computing devices (104), the set of parameters pertaining to a predefined set of instructions associated with the plurality of APIs;
based on the received set of parameters, arrange, by an API flow module (360), the plurality of APIs into one or more batches, wherein the API flow module (360) is associated with the processor (202); and,
display, by the API flow module (360), a single API from each batch to the user.
